(19) United States
(12) Patent Application Publication
(10) Pub. No.: US 2026/0127201 A1
(43) Pub. Date: May 7, 2026

(54) COMPRESSING TOOL PROMPTS VIA RELATIVE INFORMATION ENTROPY

(71) Applicant: International Business Machines Corporation, Armonk, NY (US)

(72) Inventors: Wen Wang, Beijing (CN); Zhong Fang Yuan, Xi'an (CN); Li Juan Gao, Xi'an (CN); He Li, Beijing (CN); Tong Liu, Xi'an (CN)

(21) Appl. No.: 18/935,832

(22) Filed: Nov. 4, 2024

(51) Int. Cl. G06F 16/33; G06F 16/31; G06F 40/30

(52) U.S. Cl. CPC G06F 16/3344; G06F 16/322; G06F 40/30

(57) ABSTRACT

Mechanisms are provided to compress a tool prompt. An original tool prompt is segmented into text chunks. At least one semantic vector representation of the text chunks is generated and a first semantic distribution of the original tool prompt is generated based on the at least one semantic vector representation. A perturbed semantic vector representation is generated by eliminating at least one text chunk from the text chunks, and a second semantic distribution is generated based on the perturbed semantic vector representation. A comparison of the first and second semantic distributions is performed to generate at least one similarity metric. A compressed tool prompt is generated based on the at least one similarity metric by eliminating one or more text chunks that have a similarity metric that is above a threshold similarity value.

### BACKGROUND

The present application relates generally to machine learning models, generative machine learning models, large language models (LLMs), artificial intelligence agents (AI agents) which are automated and can perform actions on their environment based on observations, and agentic interaction with LLMs.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided that comprises receiving an original tool prompt, and segmenting the original tool prompt into multiple text chunks. The method further comprises generating at least one semantic vector representation of the multiple text chunks. The method also comprises generating a first semantic distribution of the original tool prompt based on the at least one semantic vector representation. In addition, the method comprises generating a perturbed semantic vector representation based on a subset of the multiple text chunks, the subset being generated by eliminating at least one text chunk from the multiple text chunks, and generating a second semantic distribution based on the perturbed semantic vector representation. The method further comprises performing a comparison of the first semantic distribution and the second semantic distribution to generate at least one similarity metric. Moreover, the method comprises, in response to the at least one similarity metric exceeding a threshold similarity value, generating a compressed tool prompt based on the subset of the multiple text chunks.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A is an example diagram of a process of a Large Language Model (LLM) agent in accordance with one illustrative embodiment;

FIG. 1B is an example diagram of a LLM task prompt which includes multiple agent tool prompts;

FIG. 2 is an example diagram illustrating one of the LLM agent tool prompts that was shown in FIG. 1B and an overview of the inventive compression process performed in accordance with one illustrative embodiment;

FIG. 3 is an example diagram of a distributed data processing system environment in which aspects of the illustrative embodiments may be implemented and at least some of the computer code involved in performing the inventive prompt compression methods may be executed;

FIG. 4 is an example block diagram illustrating another distributed computing environment in which the inventive compression methods are carried out and including the primary operational components of a LLM agent tool prompt compressor in accordance with one illustrative embodiment;

FIG. 5 is an example diagram illustrating operations for performing a vector space modeling of a tool prompt in accordance with one or more illustrative embodiments;

FIG. 6 is an example diagram illustrating operations for performing importance assessment of text chunks in accordance with one illustrative embodiment; and

FIG. 7 is a flowchart outlining an example operation for compressing a LLM agent tool prompt in accordance with one illustrative embodiment.

### DETAILED DESCRIPTION

A Large Language Model (LLM) is a is a type of artificial intelligence (AI) model that is designed to understand and generate human language. LLMs are trained on vast amounts of text data and use deep learning techniques to perform various natural language processing tasks, such as text generation, translation, and summarization. Examples of LLMs include IBM's Granite, OpenAI's GPT models, Google's Gemini, and Meta's Large Language Model Meta AI (LLaMA).

An LLM agent is an AI computing system that is built around an LLM which acts as the core computational engine. The LLM agent extends the LLM's capabilities beyond text generation and provides additional logic and tools by which the LLM may be used to perform other tasks, perform reasoning, and provide autonomous abilities. LLM agents use prompts, i.e., text that can be processed and interpreted by LLMs, which specify the persona of the LLM, instructions to the LLM as to the functions it is to perform, and other information that specifies how the LLM agent is to operate, what actions it is to perform, and the types of responses the LLM is to provide. The LLM agent may comprise various tools, e.g., calculators, application programming interfaces (APIs), search engines, and the like, which are accessible to the LLM via one or more tool prompts and which the LLM can use to gather information, perform computations and actions to complete tasks, and the like.

The illustrative embodiments provide a computing tool and computing tool operations/functionality for compressing LLM agent tool prompts based on relative information entropy. The following description provides examples of embodiments of the present disclosure, and variations and substitutions may be made in other embodiments. Several examples will now be provided to further clarify various aspects of the present disclosure.

Example 1: A computer implemented method is provided that comprises receiving an original tool prompt and segmenting the original tool prompt into multiple text chunks. The method further comprises generating at least one semantic vector representation of the multiple text chunks, and generating a first semantic distribution of the original tool prompt based on the at least one semantic vector representation. The method also comprises generating a perturbed semantic vector representation based on a subset of the multiple text chunks, the subset being generated by eliminating at least one text chunk from the multiple text chunks, and generating a second semantic distribution based on the perturbed semantic vector representation. In addition, the method comprises performing a comparison of the first semantic distribution and the second semantic distribution to generate at least one similarity metric. Furthermore, the method comprises generating a compressed tool prompt based on the subset of the multiple text chunks.

The above limitations advantageously enable the compression of tool prompts by removing unnecessary or redundant information present in portions of an original tool prompt. By reducing the amount of unnecessary or redundant textual portions, or context tokens, in the tool prompts, fewer resources are needed to process the compressed tool prompt and available space within generative machine learning computer model limits is made available to provide more tool descriptions, enabling more complex agents for such generative machine learning computer models to be defined and utilized.

Example 2: The method of any of Examples 1 and 3-13, where the method further comprises storing the compressed tool prompt in a data storage that is accessible to an artificial intelligence agent that communicates with the generative machine learning model. The above limitation advantageously permits an AI agent to utilize and reuse such compressed tool prompts with corresponding generative machine learning models and/or different generative machine learning models.

Example 3: The method of any of Examples 1-2 and 4-13, where the method further comprises adding the compressed tool prompt to a task prompt, inputting the task prompt into a generative machine learning model, in response to the inputting, receiving a task output from the generative machine learning model. The above limitations advantageously allow for compressed tool prompts to be used with generative machine learning models in a manner that reduces the amount of resources and processing time to process the tool prompt, yet provides sufficient context to permit accurate operation of the generative machine learning model.

Example 4: The method of any of Examples 1-3 and 5-13, where the original tool prompt helps define a function tool and comprises one or more defining elements selected from a group consisting of: a function declaration specifying an identifier of the function tool, a function description that describes what the function tool does, a parameter description that describes parameters used by the function tool, and a return description that describes a type of output to be provided by the function tool in response to the function tool being invoked. The above limitations advantageously permit the specification of the necessary components of a tool prompt for invoking an operation of a generative machine learning model to perform a function for accomplishing a task.

Example 5: The method of any of Examples 1-4 and 6-13, where the original tool prompt comprises a first number of the defining elements and the compressed tool prompt comprises a second number of the defining elements, the second number being smaller than the first number. The above limitations advantageously permit the compression of the tool prompt to a smaller size which leads to fewer resources and processing time needed to process the tool prompt by a generative machine learning model.

Example 6: The limitations of any of Examples 1-5 and 7-13, further comprising generating an associative tree data structure based on the plurality of text chunks and at least one similarity metric. The at least one similarity metric comprises a plurality of similarity metrics and connections between nodes of the associative tree data structure comprise corresponding ones of these similarity metrics. These similarity metrics specify a similarity between nodes connected by a corresponding connection. The above limitations advantageously enable the identification of unnecessary or redundant portions of tool prompts using a tree data structure in which nodes correspond to text chunks in the original tool prompt and elimination of nodes through a tree pruning operation enables removal of such unnecessary or redundant portions.

Example 7: The limitations of any of Examples 1-6 and 8-13, where generating the compressed tool prompt comprises pruning the associative tree data structure by removing nodes and paths which have only connections whose corresponding similarity metrics meet a predetermined criterion, to thereby generate a pruned associative tree data structure. The above limitations advantageously enable the reduction of the textual content of tool prompts by removing nodes and paths that have low semantic significance within the tool prompt, as determined by the predetermined criterion.

Example 8: The limitations of any of Examples 1-7 and 9-13, where generating the compressed tool prompt comprises traversing the pruned associative tree data structure to reconstruct a tool prompt that comprises less textual content than the original tool prompt. The above limitations advantageously enable the generation of a tool prompt from a pruned associative tree data structure which maintains the semantics of the original tool prompt but minimizes redundancy and unnecessary content of the original tool prompt. This improves the operation of the generative machine learning model agent by reducing the amount of content of the tool prompt that needs to be processed.

Example 9: The limitations of any of Examples 1-8 and 10-13, where the at least one similarity metric is generated by executing at least one of a first algorithm that measures a largest difference between the first semantic distribution and the second semantic distribution, and a second algorithm that measures how much the first semantic distribution and the second semantic distribution agree or differ. The above limitations advantageously enable the generation of a comprehensive dissimilarity indicator which quantifies the difference of two distributions, such that the unnecessary or redundant nodes in an associative tree data structure may be identified and pruned, which in turn allows for the generation of a tool prompt.

Example 10: The limitations of any of Examples 1-9 and 11-13, where the first algorithm is a K-S test algorithm, and the second algorithm is a Jensen-Shannon divergence algorithm. The above limitations advantageously enable the use of the K-S test algorithm to measure the largest difference between two paths (distributions), while the Jensen-Shannon divergence is used to measures how much two maps (distributions) agree or differ. In this way, a comprehensive identification of dissimilarity between two distributions is generated which provides a more accurate identification of which portions of the tool prompt are unnecessary or redundant with regard to the semantics of the tool prompt.

Example 11: The limitations of any of Examples 1-10 and 12-13, where segmenting the original tool prompt into multiple text chunks comprises parsing the original tool prompt and generating text chunks based on an identification of at least one of tags, key words, phrases, or structural elements specific to functional tool descriptions in tool prompts. The above limitations advantageously enable automated parsing and segmentation of the tool prompt in a manner that is customized to the specific content and structure of tool prompts. The resulting segments will thus, represent specific tool prompt segments or text chunks that have semantic meanings.

Example 12: The limitations of any of Examples 1-11 and 13, where generating the first semantic distribution comprises processing the at least one semantic vector representation via a Gaussian Mixture Model (GMM), and wherein generating the second semantic distribution comprises processing the perturbed semantic vector representation via the GMM. The above limitations advantageously enable the leveraging of the functionality of a GMM to product the semantic distributions for identifying which portions, or text chunks, of a tool prompt may contain unnecessary or redundant semantic information which may be eliminated to compress the tool prompt.

Example 13: The limitations of any of Examples 1-12, where generating at least one semantic vector representation of the multiple text chunks comprises generating a separate semantic vector representation for each text chunk in the multiple text chunks, and wherein generating the perturbed semantic vector representation comprises generating a separate perturbed semantic vector representation for each text chunk in the multiple text chunks other than the eliminated at least one text chunk. The above limitations advantageously enable the identification of unnecessary or redundant text chunks by making perturbations to the semantic vector representations which, along with the similarity metric generation, identifies which perturbations cause significant differences and which do not. Those that cause significant differences are considered to have high self-information whereas those that do not are considered to have low self-information and hence, may be eliminated without appreciably affecting the semantics of the original tool prompt.

Example 14: A system comprising one or more processors and one or more computer-readable storage media collectively storing program instructions which, when executed by the one or more processors, are configured to cause the one or more processors to perform a method according to any one of Examples 1-13. The above limitations advantageously enable a system comprising one or more processors to perform and realize the advantages described with respect to Examples 1-13.

Example 15: A computer program product comprising one or more computer readable storage media, and program instructions collectively stored on the one or more computer readable storage media, the program instructions comprising instructions configured to cause one or more processors to perform a method according to any one of Examples 1-13. The above limitations advantageously enable a computer program product having program instructions configured to cause one or more processors to perform and realize the advantages described with respect to Examples 1-13.

As mentioned above, the illustrative embodiments provide a computing mechanisms for compressing LLM agent tool prompts based on relative information entropy. LLM agents leverage various function tools for enhancing the capabilities of LLMs. The function tools are input to the LLM in a specific prompt format, referred to as a tool prompt. A tool prompt will often include some or all of a function declaration specifying the identifier of the function, a function description that describes what the function tool does, a parameter description that describes the parameters used by the function tool, and a return description that describes the type of output that the function tool will provide when invoked by the LLM agent.

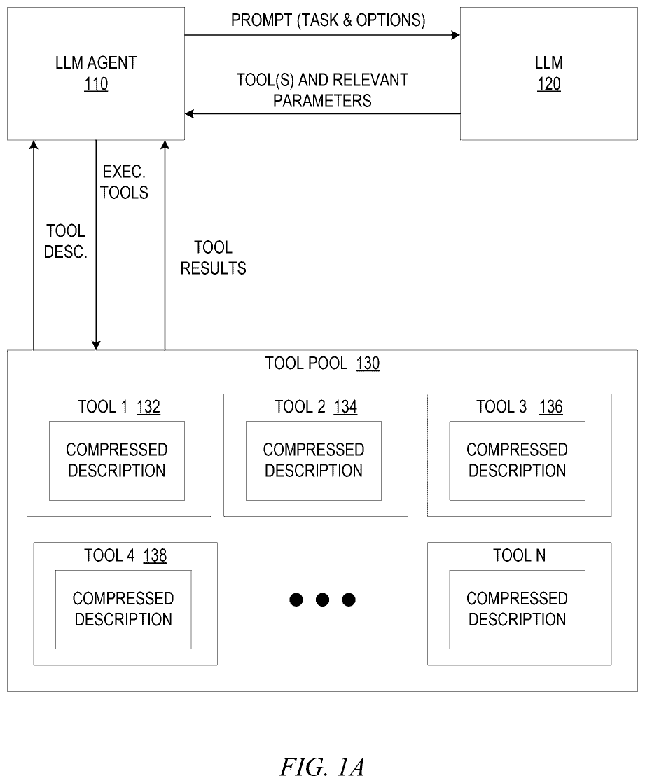

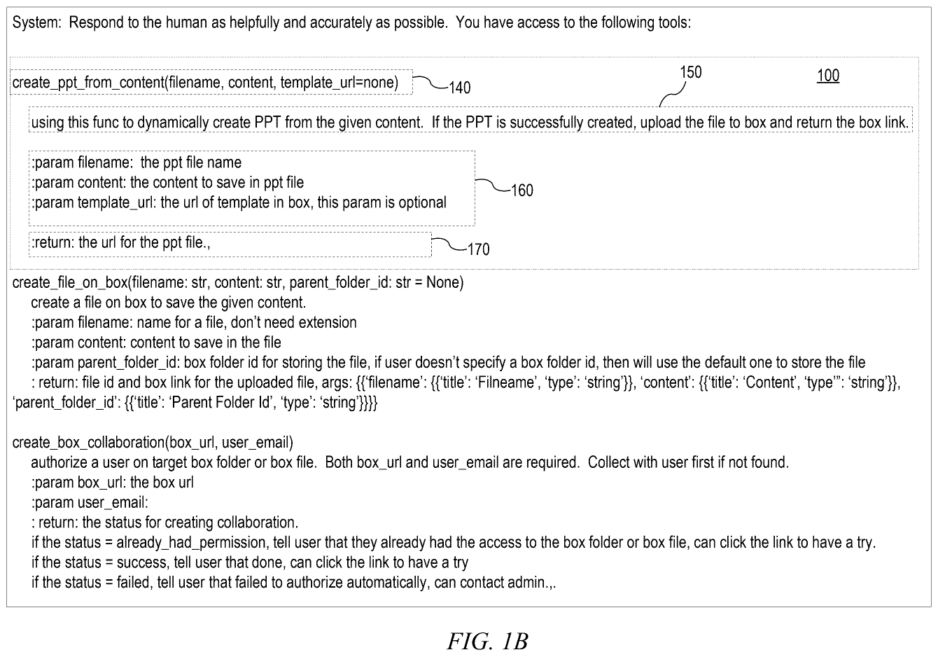

FIG. 1A is an example diagram illustrating an operation of an LLM agent in accordance with one illustrative embodiment. As shown in FIG. 1A, the LLM agent 110 operates in conjunction with an LLM 120. The only thing that the LLM 120 accepts as input is a prompt input. Thus, the LLM agent 110 calls the LLM 120 with a prompt telling the LLM 120 what the task is and what kind of tools the LLM 120 has to accomplish the task, and lets the LLM 120 make the decision on which of these tools to use and what are the relevant parameters for calling those tools. The LLM 120 can generate a decision of which tools to utilize, but it is the LLM agent 110 that executes the tools based on this LLM 120 decision. The LLM 120 can only generate text and cannot interact directly with the tools.

The LLM agent 110 executes the tools, obtains the tool results, and adds the results to a prompt to call the LLM 120 again, i.e., to let the LLM give a decision and invoke any additional tools that may be needed in an iterative manner until the decision of the LLM 120 is a FINAL_ANSWER, which means the process can be finished.

As noted above, the LLM agent 110 needs to prepare the prompt before calling the LLM 120. In accordance with the illustrative embodiments, the LLM agent 110 is an artificial intelligence (AI) agent, meaning a system or program that is capable of autonomously performing tasks on behalf of a user or another system by designing its workflow and utilizing available tools. AI agents can encompass a wide range of functionalities beyond natural language processing including decision-making, problem-solving, interacting with external environments and executing actions. These AI agents can be deployed in various applications to solve complex tasks in various enterprise contexts from software design and IT automation to code-generation tools and conversational assistants. The AI agents use the advanced natural language processing techniques of large language models (LLMs) to comprehend and respond to user inputs step-by-step and determine when to call on external tools.

AI agents may comprise memory which allows storage of past interactions and decisions. AI agents use tool calling on the backend to obtain up-to-date information, optimize workflows, and create subtasks autonomously to achieve complex goals.

In this process, the autonomous AI agent, i.e., LLM agent 110, learns to adapt to user expectations over time. The LLM agent's ability to store past interactions in memory and plan future actions encourages a personalized experience and comprehensive responses. This tool calling can be achieved without human intervention and broadens the possibilities for real-world applications of these AI systems. The approach that AI agents take in achieving goals set by users is comprised of these three stages: (1) goal initialization and planning, (2) reasoning using available tools, and (3) learning and reflection. Although AI agents are autonomous in their decision-making processes, they require goals and environments defined by humans.

AI agents use feedback mechanisms, such as other AI agents and human-in-the-loop (HITL), to improve the accuracy of their responses. AI agents may also be referred to as LLM agents, such as LLM agent 110, and in some instances implement a Reasoning and Action (ReAct) architecture as a form of Chain-of-Thought prompting. The AI agents include goal-based agents, utility-based agents, and learning agents.

The LLM agent 110 uses a tools related prompt to prompt the LLM 120 to perform its decisions and ultimately obtain a final result. A tools related prompt provides the descriptions of a list of tools available. For each tool, the tools related prompt has a similar structure including the tool name, description of the tool, required parameters of the tool, and description of each parameter of the tool. It should be appreciated that such tool related prompts may list only a few available tools or may list hundreds or even thousands of tools available to the LLM 120 for performing the given task and thus, the specification of the available tools in the tools related prompt may represent a large portion of the prompt.

The illustrative embodiments provide mechanisms to compress the specification of the tools in such tool related prompts. This compression may be performed when a tool is created or updated so that the LLM agent 110 may generate a tool related prompt for the LLM 120 using a compressed representation of the tool in the tool related prompt. That is, the source of tool related prompt is the description of each tool and the integration of this description into the template of the tool related prompt generated by the LLM agent 110. For most cases, each time the agent loads the description of the tool from the tool pool 130, these descriptions will be loaded such that they only need to be compressed when the tool 132-138 is created or updated in the tool pool 130. In some cases, however, the tool prompt can be compressed at the stage when LLM agent 110 calls the LLM 120, such as when an update or access to the source tools in the tool pool 130 is not able to be performed.

These tool related prompts are also referred to herein as simple a “tool prompt”. An example of a tool prompt is shown in FIG. 1B. As shown in FIG. 1B, three different tool prompts are specified and are part of an overall task prompt to be input to an LLM. The three tool prompts include a “create_ppt_from_content” tool, a “create_file_on_box” tool, and a “create_box_collaboration” tool, with their corresponding function descriptions, parameter descriptions, and return descriptions. For example, for the “create_ppt_from_content” tool 140, the function tool's declaration 150 comprises the function tools name and parameters passed to the function tool. The function tool's description 160 specifies that the function is used to dynamically create PPT from a given content and that if it is successfully created, the file is uploaded to box and the box link is returned, where “box” refers to the IBM Box service which is a secure cloud-based file sharing service for managing, governing, and collaborating on content. The parameter description 130 provides a listing of the parameters utilized by the function tool and specifies what these parameters are and other characteristics of the parameter, e.g., whether the parameter is optional. The return description 170 specifies what the function tool returns as a result of its operation.

To boost development efficiency, some LLM frameworks offer the ability to automatically generate function tool prompts based on function definitions in the code of the function tool. Whether created automatically by the LLM, or manually by human beings, it can be seen from the simplified example of FIG. 1B that the functional tool prompts contain a significant amount of redundant information. This redundancy grows as the number of function tools specified in a function tool prompt increases. This becomes a significant problem with LLM agents as the LLM agent capabilities become more complex and increasing numbers of function tools are included in the LLM agent, leading to larger tool prompts. The larger the tool prompt becomes, i.e., the higher the number of prompt tokens used in the tool prompt, the higher the computational cost of the LLM which must process the tool prompt. Moreover, LLMs have a context token limit which is consumed by the redundant information, leading to the inability to add additional functional tools to the tool prompt.

General compression techniques for compressing text cannot be applied to the functional tool descriptions in tool prompts of LLM agents. The LLM agent's functional tools are often custom functions with a relatively large amount of self-information, such that general text compression effects are poor, i.e., not very much of the text is compressed. Self-information is used to evaluate the amount of information that the portion of text contains. For example, in the textual content “I'm from Beijing, the capital of China,” the phrase “I'm from Beijing” has high self-information, but “the capital of China” has low self-information as Beijing is already known to the LLM to be the capital of China from its training. In the case of a tool prompt, tool definitions use some abbreviations, domain words, and customized or self-defined words, so that there is high self-information within the context of an LLM. However, some portions of the tool prompt are expansions of other parts so that they will have low self-information relative to other portions of the tool prompt. Thus, self-information is a measure of how much new information is present in the corresponding portion of text, with high self-information indicating the text having significant new information, whereas a low self-information indicates no, or very little, significant new information is present in the text.

Moreover, the functional tool description in the tool prompt follows certain specifications, such as the requirement for the function identification, function description, parameter description, and return description noted above. There is a mutual explanation relationship between these portions 140-170 of the functional tool description 100, such that general text compression methods do not work well as they ignore the internal relationships between these portions in the functional tool descriptions of the tool prompt.

Thus, it would be beneficial to be able to efficiently compress the functional tool descriptions, e.g., portions 140-170 in FIG. 1B for each functional tool, in the tool prompt by automatically identifying and reducing redundant or unnecessary information. This would allow for the conveying of more meaningful information in a compact manner to the LLM given the LLM's content token limits. Moreover, this would reduce computational costs of LLM agents for LLM invocations using tool prompts. Furthermore, this would enable more complex LLM agents to be developed by providing additional space in tool prompts for the specification of additional functional tools that may be utilized by the LLM agents to increase functionality without exceeding a token limit of an LLM.

The illustrative embodiments provide a computing tool and computing tool operations/functionality to identify unnecessary information, or information that is redundant, in functional tool descriptions of a LLM agent's tool prompt. The illustrative embodiments implement a vector space modeling of the LLM agent tool prompt, which involves splitting the prompt into semantically independent text chunks and encoding each of the chunks into a corresponding vector representation through a LLM encoder. The illustrative embodiments further implement an importance assessor for the text chunks which evaluates the significance of the text chunks through differential analysis of data distributions based on the vector encodings. Moreover, the illustrative embodiments further implement a compressed tool prompt generator which operates to construct an associative tree based on the results of the importance assessment from the importance assessor and then eliminate paths with relatively low semantic information while retaining paths with high semantic information nodes. This results in a “pruned” associative tree where some nodes of the tree are eliminated or not further considered. The compressed tool prompt generator then traverses the resulting pruned associative tree and reorganizes the pruned associative tree to generate the new compressed tool prompt.

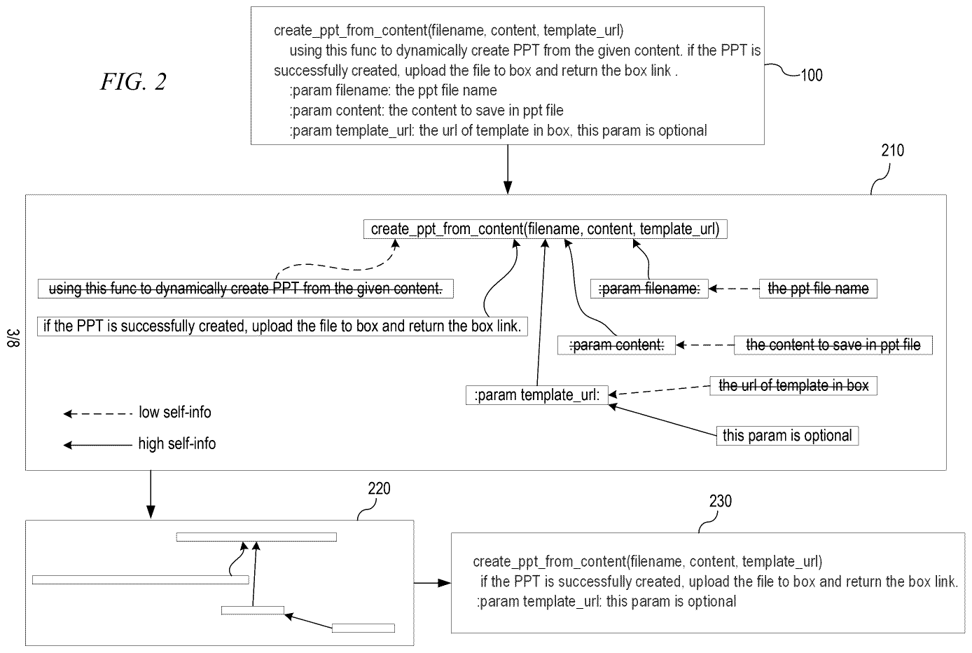

FIG. 2 is an example diagram illustrating one of the LLM agent tool prompts that was shown in FIG. 1B and an overview of the compression process performed in accordance with one illustrative embodiment. As shown in FIG. 2, the example LLM agent tool prompt 100 is the same as in FIG. 1B for the “create_ppt_from_content” functional tool. As shown in FIG. 2, the LLM agent tool prompt 100 is separated into text chunks corresponding to semantically significant segments or blocks, e.g., lines of the function description and portions of the parameter definitions, so as to generate an associative tree 210 where the nodes of the associative tree 210 correspond to these different text chunks. The nodes of the paths in the associative tree 210 are evaluated, or scored based on one or more algorithms that determine a similarity/dissimilarity between the nodes, to identify which nodes and corresponding paths have low self-information and those that have high self-information.

The nodes and paths that are determined to have low self-information are eliminated or removed from further consideration and may result in a pruned associative tree 220 where these nodes and paths have been removed. The pruned associative tree 220 may then be traversed to generate a new compressed functional tool description 230 in which the low self-information portions are not present in the new compressed functional tool description 230. The new compressed LLM agent tool prompt 230 has fewer context tokens than the original LLM agent tool prompt 100. Thus, the compressed prompt 230 requires fewer context tokens to be processed by the LLM and does not consume as much of the context token limit of the LLM.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a LLM agent tool prompt compressor. The improved computing tool implements mechanisms and functionality, such as the vector space modeler, importance assessor, and compressed tool prompt generator of the LLM agent tool prompt compressor, which cannot be practically performed by human beings either outside of, or with the assistance of, a technical environment, such as a mental process or the like. The improved computing tool provides a practical application of the methodology at least in that the improved computing tool is able to compress tool prompts of LLM agents by automatically identifying portions of the tool prompts that are unnecessary or redundant and removing those portions to thereby compress the functional tool descriptions in the tool prompt.

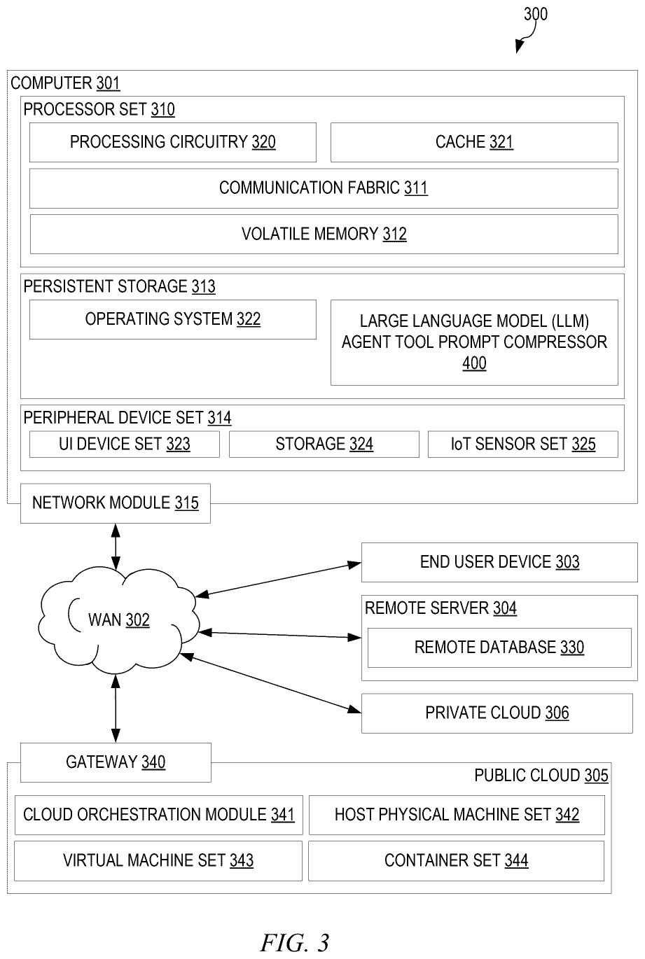

FIG. 3 is an example diagram of a distributed data processing system environment in which aspects of the illustrative embodiments may be implemented and at least some of the computer code involved in performing the inventive methods may be executed. That is, computing environment 300 contains an example of an environment for the execution of at least some of the computer code involved in performing the inventive methods, such as LLM agent tool prompt compressor 400. In addition to LLM agent tool prompt compressor 400, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and LLM agent tool prompt compressor 400, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in LLM agent tool prompt compressor 400 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface type operating systems that employ a kernel. The code included in LLM agent tool prompt compressor 400 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

As shown in FIG. 3, one or more of the computing devices, e.g., computer 301 or remote server 304, may be specifically configured to implement a LLM agent tool prompt compressor 400. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 301 or remote server 304, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates compression of LLM agent tool prompts by minimizing the amount of unnecessary and/or redundant information in LLM agent tool prompts to thereby improve tool prompt processing by LLM agents.

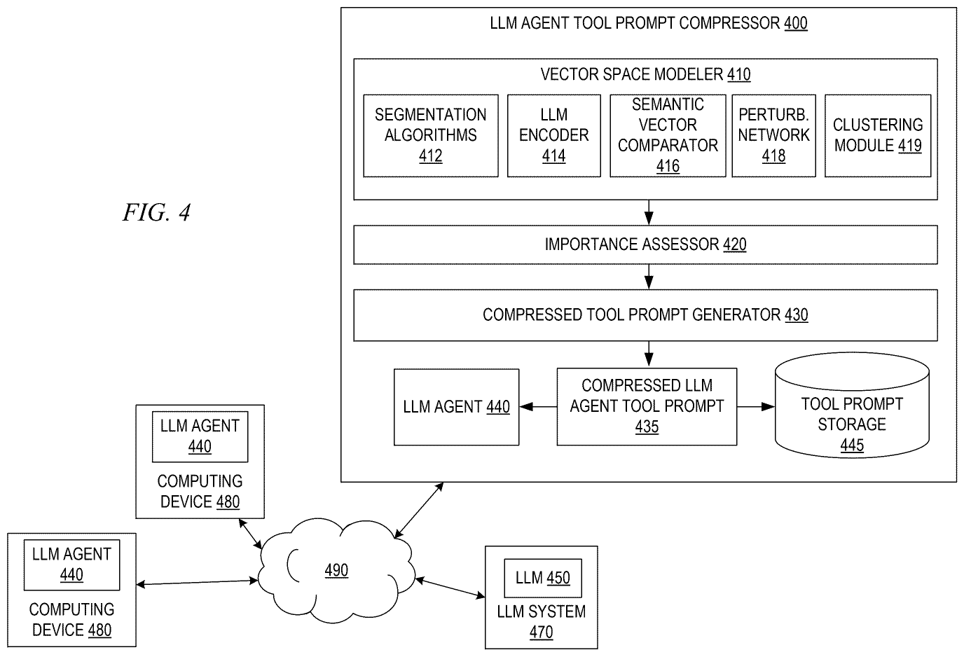

FIG. 4 is an example block diagram illustrating the primary operational components of a LLM agent tool prompt compressor in accordance with one illustrative embodiment. The operational components shown in FIG. 4 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that LLM agent tool prompts are formulated so as to improve the efficiency of operation of the LLM agent by compressing the tool prompts to remove unnecessary or redundant information. The illustrative embodiments provide mechanisms to perform vector space modeling of tool prompts, importance assessments of text chunks of the tool prompt, and compression of the tool prompt using an associative tree and pruning logic, which cannot be practically performed by human beings as a mental process and is not directed to organizing any human activity.

As shown in FIG. 4, the LLM agent tool prompt compressor 400 includes a vector space modeler 410, an importance assessor 420, and a compressed tool prompt generator 430. In some illustrative embodiments, the LLM agent tool prompt compressor may be part of the same computing system upon which one or more LLM agents 440 and/or a LLM 450, are provided. In other illustrative embodiments, one or more of the components 440, and 450 may be provided on separate computing systems from the other components. For example, the LLM 450 may be provided by one or more LLM computing systems 470 and the LLM agents 440 may be associated with other computing systems 480. In any desired implementation, these components are in data communication with one another either internally within the same computing system or via one or more data networks 490 in a distributed environment implementation. The LLM agents 440 employ the LLM 450 to perform computational operations in accordance with the logic and tools of the LLM agents 440 using appropriately constructed LLM prompts, some of which may include LLM agent tool prompts, such as those discussed above.

Thus, in accordance with the illustrative embodiments, the LLM agent tool prompt compressor operates on LLM agent tool prompts developed for the LLM agents 440 and the LLM 450. These LLM agent tool prompts may be developed by one or more subject matter experts and/or automated tools associated with LLMs, and each LLM agent tool prompt may specify one or more functional tools available to the LLM agent 440 and LLM 450 via a functional tool definition that follows a predefined structure, e.g., functional tool identifier, functional tool description, functional tool parameter description, and functional tool response description. This particular structure is used for illustration purposes and is not intended to be limiting. Any suitable predefined structure may be used without departing from the spirit and scope of the present invention.

The operation of the LLM agent tool prompt compressor may be initiated in response to an LLM agent tool prompt being generated and/or modified, for example, or in response to an automated or manually input request to compress a given LLM agent tool prompt. The original LLM agent tool prompt is input to the LLM agent tool prompt compressor which then processes the LLM agent tool prompt through the vector space modeler 410, an importance assessor 420, and a compressed tool prompt generator 430, to thereby generate a new compressed LLM agent tool prompt 435 which is then stored in an LLM agent tool prompt storage 445 in association with the LLM agent 440 for later use.

The vector space modeler 410 comprises computer executable logic that segments the functional tool descriptions of the original LLM agent tool prompt to thereby divide the text of these functional tool descriptions into several text chunks. The segmentation of the text into text chunks may be implemented using any suitable text parsing and segmentation algorithms 412 which are configured to specifically process the functional tool descriptions of LLM agent tool prompts. For example, the text parsing and segmentation algorithms 412 may be configured to identify particular tags, key words, phrases, structural elements, and the like, that are specific to functional tool descriptions in LLM agent tool prompts. For example, knowing that the structure of a functional tool description has portions 140-170 in FIG. 1B, the segmentation algorithms may be configured to identify these different portions based on the structure, identify key terms, such as “param” or “return”, and the like. The segmentation algorithms 412 are able to segment such functional tool descriptions in the LLM agent tool prompts based on this configuration and knowledge, as well as identify, and segment into text chunks, other elements of the LLM agent tool prompts, such as the persona of the LLM specification, instructions to the LLM as to the functions it is to perform, and other information that specifies how the LLM agent is to operate, what actions it is to perform, and the types of responses the LLM is to provide.

In accordance with the illustrative embodiments, it is assumed that some of these text chunks will include unnecessary or redundant information, which may be removed from the LLM agent tool prompt without affecting the functionality of the original LLM agent tool prompt. In order to determine which text chunks comprise such unnecessary or redundant information, the text chunks are input to a LLM encoder 414 which encodes the text chunks into corresponding semantic vector representations. Semantic vectors are high dimensional vector models derived from term-document matrices, and are used to determine semantic similarity between portions of text based on their contextual relationships in a corpus of text, where in the present case, the corpus may be considered to be the LLM agent tool prompt. The semantic vector embedding of a portion of text is performed using trained deep learning models, trained on a knowledge base, to generate semantic vector embeddings that represent semantic relationships in text based on the knowledge base. LLM encoding of portions of text into semantic vector representations is generally known in the art and thus, a more detailed explanation of this process is not included herein. Such LLM encoding is applied to the particular text chunks generated from the segmentation of the LLM agent tool prompt.

It should be appreciated that, by inputting each text chunk into the LLM encoder 414, a plurality of semantic vectors is generated, one semantic vector for each text chunk. These semantic vectors of the text chunks may then be input to a semantic vector comparator 416 which may compare the semantic vector representations of the text chunks to determine semantic vector similarities and identify which text chunks comprise redundant and unnecessary information, e.g., information that is semantically similar to other chunks or other chunk portions or of little semantic value. That is, for example, in some illustrative embodiments, semantic vectors that have a sufficiently high semantic vector similarity, e.g., above a predetermined threshold, may be determined to be sufficiently similar as to warrant removal of at least one of the text chunks of the compared semantic vector representations.

In other illustrative embodiments, it is recognized that such vector comparisons on the semantic vectors themselves may not take into consideration all variations in the way that text chunks may represent similar concepts in LLM agent tool prompts. Thus, to make the identification of unnecessary or redundant portions of the LLM agent tool prompt more robust, the vector space modeler 410 may further include a perturbation network 418 and a clustering module 419 to represent the semantic distribution of the original LLM agent tool prompt. The clustering module in some embodiments performs clustering on semantic vectors to produce an output such as a Gaussian Mixture Model (GMM) whose parameters are a parametric representation of the original LLM agent tool prompt in a semantic space. The perturbation network 418, which in some illustrative embodiments may be a fully-connected (FC)-network with dropout (randomly selected abandonment of a neuron, e.g., the neuron value is set to 0) for example, randomly perturbs the original vector in the vector space to generate a plurality of different homogenous vectors in the semantic vector space. The homogenous vectors are similar in nature or share a common structure or space, but may different slightly while still representing the same type of information or concept. This is opposed to heterogeneous vectors that are fundamentally different and possibly represent distinct types of information or may be coming from different vector spaces. In some illustrative embodiments, portions of the vector are dropped to determine the significance of these dropped portions as compared to the overall semantics of the original semantic vector. If the dropped portion does not change the semantics of the original semantic vector appreciably, then that dropped portion may be determined to be unnecessary.

Thus, with a FC-network, for example, the FC-network applies a linear transformation to the input vectors which maps the input to another vector space but does not drastically change the nature or meaning of the input. The dropout randomly deactivates one or more nodes in the network to introduce randomness, which acts as a form of regularization. This introduces slight variations to the output vectors but does not destroy the core information from the input. The dropout adds small random perturbations to these vectors, but since it is a controlled and partial modification (by deactivating random nodes), the dropout creates variations that are small in scale. These changes introduce randomness without altering the core meaning of the vectors. Thus, the output vectors still represent the same semantic meaning but with slight variations or perturbations. This is why theses resulting vectors are considered homogeneous, as they are still essentially the same in nature, despite small random differences.

After generating the various homogenous vectors, the original LLM agent tool prompt can be transformed into a high-dimension embedding in a larger vector distribution. The clustering module 419 operates on this larger vector distribution, i.e., the set of homogeneous vectors generated by the perturbation network 418, to represent the semantic distribution of the vectors mathematically. The clustering module 419 receives the set of homogenous vectors as input and clusters these vectors to produce a model such as a GMM whose parameters are a parametric representation of the original LLM agent tool prompt in the semantic space. Thus, the original LLM agent tool prompt may be quantified by the parameters of the GMM and the produced GMM serves as a spatial identifier. Thereafter, an importance test can be performed on each text chunk.

In addition to the vector similarity comparison operations described above in some illustrative embodiments, the importance testing of the text chunks using the larger distributions of vectors from the perturbations and the semantic distribution quantifying of the GMM 419, can be performed by the importance assessor 420. The importance testing, in some illustrative embodiments, involves sequentially extracting each text chunk from the original LLM agent tool prompt. After extracting the text chunk, it is modeled using the perturbation network 418 and the clustering module 419, resulting in another GMM distribution, which is denoted as GMM-cmp (compare). At this point, the GMM-cmp is compared to the original GMM distribution at the level of data distribution, and the degree of difference is recorded. If the results of the comparison between the comparison GMM distribution, GMM-cmp, and the original GMM distribution is minimal, e.g., below a predetermined threshold, at the data distribution level, this indicates that the text chunk is not crucial in latent semantics and can be deleted to reduce prompt length and complexity.

In order to compare the differences between two GMM distributions, such as the original GMM distribution and the GMM-cmp distribution, at the data distribution level, a hybrid approach may be used in some illustrative embodiments. In this hybrid approach a K-S test is combined with a Jensen-Shannon divergence. This approach comprehensively captures both similarity and dissimilarity between the two GMM distributions. The K-S test approach uses a Kolomogorov-Smirnov test (K-S test) to measure the maximum difference in cumulative distribution functions (CDF) between the two GMM distributions. The K-S test statistical value determines whether the two distributions are derived from the same population. A smaller statistic value suggests greater similarity between the distributions.

The Jensen Shannon divergence measures the similarity between two probability distributions. Jensen-Shannon divergence is the average of Kullback-Leibler divergences, considering the relative entropy between the two distributions. A smaller Jensen-Shannon divergence indicates greater similarity between the distributions.

Thus, the K-S test measures the largest difference between two paths (distributions). The Jensen-Shannon divergence measures how much two maps (distributions) agree or differ. With the K-S test, the Kolmogorov-Smirnov test (K-S test) is first used to measure the maximum difference in cumulative distribution functions (CDF) between the two GMM distributions. The K-S test statistic helps determine whether the two distributions are derived from the same population. A smaller statistic indicates greater similarity between the distributions. The Jensen-Shannon divergence is then used to measure the similarity between the two probability distributions. Jensen-Shannon divergence is the average of Kullback-Leibler divergences, taking into account the relative entropy between the two distributions. A smaller Jensen-Shannon divergence indicates greater similarity between the distributions.

By combining these two metrics of K-S test and Jensen-Shannon divergence, a comprehensive dissimilarity indicator can be defined which quantifies the difference of two distributions. For instance, a weighted average of the K-S test statistic and the Jensen-Shannon divergence provides a more thorough reflection of the differences between the two GMM distributions at the data distribution level. It should be appreciated that K-S test and Jensen-Shannon divergence are only examples of mechanisms for comparing two distributions to determine their similarity/dissimilarity and the present invention is not limited to such. Rather, there are other mechanisms that may be utilized, such as Earth Mover's distance, Chi-Squared test, Kullback-Leibler divergence, and the like, which may be used in addition to, or in replacement of, one or more of the K-S test and Jensen-Shannon divergence without departing from the spirit and scope of the present invention.

Based on the results of the comparisons of the vectors and/or distributions performed by the semantic vector comparator 416, which essentially scores each path between nodes in tree data structure, a pruned associative tree data structure is generated by the compressed tool prompt generator 430. The pruned associative tree data structure comprises a tree data structure in which nodes correspond to text chunks of the original LLM agent tool prompt, but in which some nodes and paths are eliminated. That is, in generating the pruned associative tree data structure, nodes and/or paths with low relative semantic information, or low self-information, are pruned from the full associative tree data structure. Paths with high semantic information, or high self-information, nodes are retained. Paths with both low semantic information and high semantic information nodes are retained in the final associative tree data structure. The determination of whether a path from one node to another is of “low” or “high” self-information can be determined based on predefined rules and thresholds and a comparison of the scoring performed by the semantic vector comparator 416 to these rules and thresholds, e.g., a score greater than 0.8 means low self-information (high similarity), whereas a score that is less than 0.5 means high self-information (dissimilar nodes), or vice versa if a different scoring is utilized. These threshold values and rules are implementation specific and may be set to any suitable value or any suitable rule without departing from the spirit and scope of the present invention. The resulting final associative tree data structure has the preserved paths interconnected within the associative tree data structure.

Having generated the final associative tree data structure, the compressed tool prompt generator 430 performs a depth-first traversal of the tree to reassemble node semantic segments, or text chunks, to generate a new compressed LLM agent tool prompt 435. Since the low semantic information paths and nodes have been eliminated from the associative tree data structure, the new compressed LLM agent tool prompt 435 does not include the text chunks, or semantic segments, of these eliminated nodes and paths. Hence, the new compressed LLM agent tool prompt 435 only includes the portions of the original LLM agent tool prompt that are not unnecessary or redundant.

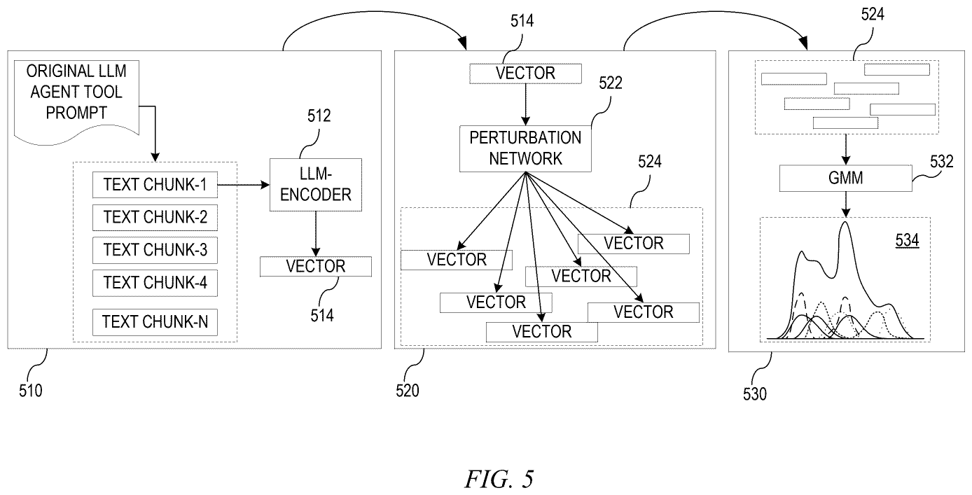

As noted above, the illustrative embodiments implement a vector space modeling by the vector space modeler 410 of the LLM agent tool prompt compressor 400. FIG. 5 is an example diagram illustrating operations for performing a vector space modeling of a tool prompt in accordance with one or more illustrative embodiments. As shown in block 510, given an original LLM agent tool prompt, the prompt is segmented into text chunks, e.g., text chunks 1 to N in FIG. 5. Each text chunk is input to an LLM encoder 512 which generates a semantic vector 514 for that text chunk. In some embodiments, embedding layers of a machine learning model are used in place of the LLM encoder 512 to generate the respective semantic vectors 514. As noted above, in some illustrative embodiments, these semantic vectors 514 may be compared using vector similarity metrics to thereby identify semantic vectors that are sufficiently similar to indicate one corresponding text chunk being unnecessary or redundant with regard to the other text chunk.

In other illustrative embodiments, as shown in block 520, the semantic vectors 514 generated by the LLM encoder 512 may each be submitted to a perturbation network 522 and a plurality of semantic vectors 524 are generated. This set of semantic vectors 524 may then be submitted, as shown in block 530, to a clustering module 532 to generate a semantic distribution 534 of the original LLM agent tool prompt. A similar approach may be used to generate the GMM-cmp distribution after having perturbed the original LLM agent tool prompt and after having then submitted it to the blocks 510-530. An importance assessment may then be performed on these distributions. This can be done for each text chunk in the plurality of text chunks generated from the original LLM agent tool prompt.

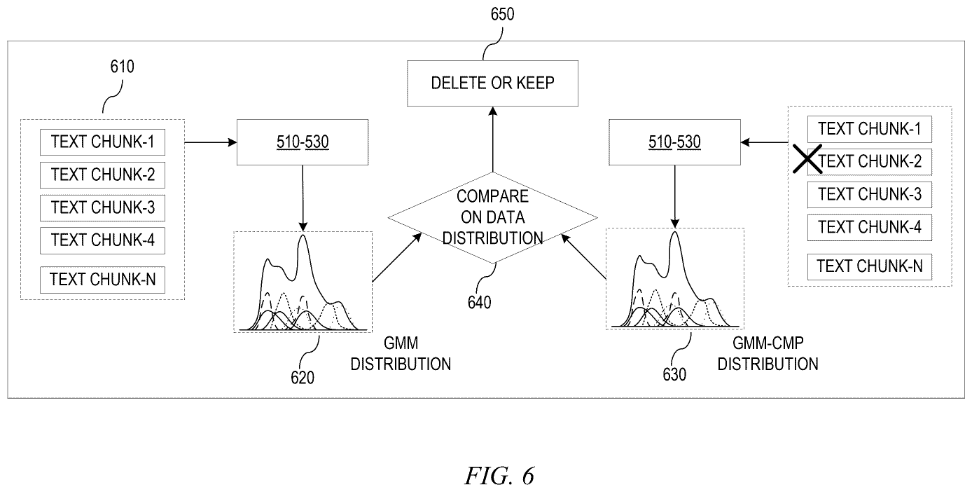

FIG. 6 provides one example diagram illustrating operations for performing importance assessment of text chunks in accordance with one illustrative embodiment. As shown in FIG. 6, the original LLM agent tool prompt is the basis for generating a set of text chunks 1 to N 610 and semantic vector representations of these text chunks are generated. The operations corresponding to blocks 510-530 are performed on the semantic vectors to generate the GMM distribution 620. Similarly, a perturbation of the text chunk semantic vectors is performed, such as removing the semantic vector corresponding to text chunk 2, and the modified set of semantic vectors are again submitted to the process of blocks 510-530 to generate the GMM-cmp distribution 630. These two distributions may then be compared 640 at the data distribution level to determine a similarity between the distributions as noted above. Based on this comparison 640, the text chunk corresponding to the perturbation, e.g., the removed semantic vector's text chunk, is either retained or eliminated 650 from further consideration when building the associative tree data structure. This may be performed for each text chunk in the original LLM agent tool prompt so as to determine which text chunks should be retained and which should not be retained when generating the final associative tree data structure. Thus, in this embodiment if one of the text chunks is eliminated the remaining text chunks are used to generate the tree data structure and ultimately the compressed tool prompt.

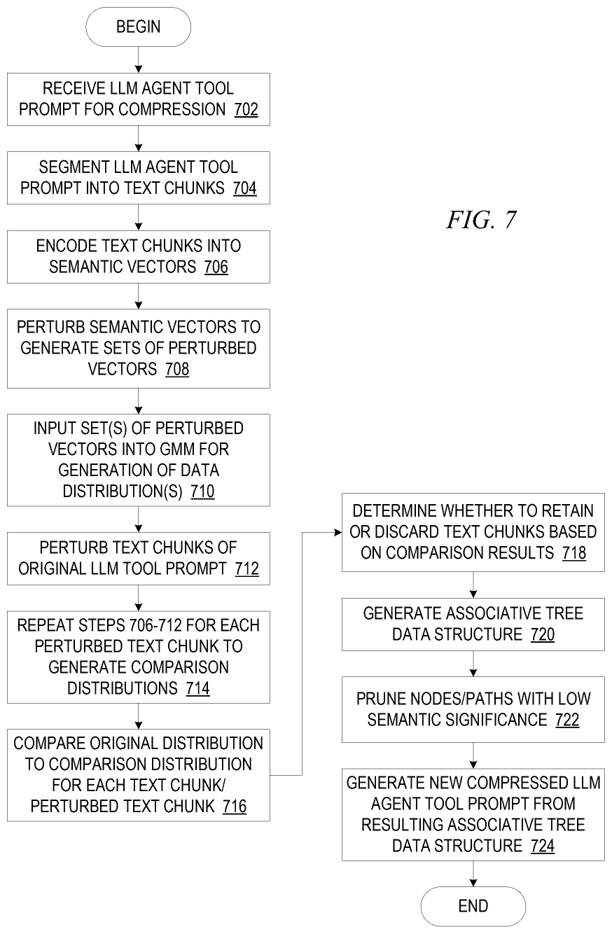

FIG. 7 presents a flowchart outlining example operations of elements of the present invention with regard to one or more illustrative embodiments. It should be appreciated that the operations outlined in FIG. 7 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 7, and may, in some cases, make use of the results generated as a consequence of the operations set forth in FIG. 7, the operations in FIG. 7 themselves are specifically performed by the improved computing tool in an automated manner.

FIG. 7 is a flowchart outlining an example operation for compressing a LLM agent tool prompt in accordance with one illustrative embodiment. As shown in FIG. 7, the operation starts by receiving an LLM agent tool prompt for compression (step 702). The LLM agent tool prompt is segmented into a plurality of text chunks (step 704) and each text chunk is encoded into a semantic vector (step 706). Each semantic vector is submitted to a perturbation network to generate a set of perturbed vectors for each semantic vector (step 708). The set of perturbed vectors are input to a GMM for generation of a data distribution (step 710). The set of text chunks of the original LLM agent tool prompt may then be perturbed (step 712) and the process repeated to generate a comparison distribution (GMM-cmp) (step 714). The two distributions may then be compared to determine a level of similarity between the distributions (step 716). Based on the similarity of the distributions, the perturbed text chunk is either identified for retaining or discarding during the generation of an associative tree data structure (step 718). Steps 712-718 may be performed for each text chunk in the set of text chunks of the original LLM agent tool prompt so as to evaluate the similarity distributions for each perturbation.

The associative tree data structure is then generated or pruned if already generated from the full set of text chunks, based on the identification of the similarity of the distributions in step 718 (step 720). For those nodes (text chunks) that are determined from the distribution similarity determinations, to be highly similar, e.g., have low semantic significance, the paths with such nodes are eliminated from the associative tree data structure, and the paths with nodes that have high semantic significance as determined from the distribution similarity determinations are retrained (step 722). The resulting associative tree data structure is then traversed depth first to generate a new LLM agent tool prompt (step 724). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving an original tool prompt for a generative machine learning model;
segmenting the original tool prompt into multiple text chunks;
generating at least one semantic vector representation of the multiple text chunks;
generating a first semantic distribution based on the at least one semantic vector representation;
generating a perturbed semantic vector representation based on a subset of the multiple text chunks, the subset being generated by eliminating at least one text chunk from the multiple text chunks;
generating a second semantic distribution based on the perturbed semantic vector representation;
performing a comparison of the first semantic distribution and the second semantic distribution to generate at least one similarity metric; and
in response to the at least one similarity metric exceeding a threshold similarity value, generating a compressed tool prompt based on the subset of the multiple text chunks.

2. The method of claim 1, further comprising storing the compressed tool prompt in a data storage that is accessible to an artificial intelligence agent that communicates with the generative machine learning model.

3. The method of claim 1, further comprising:
adding the compressed tool prompt to a task prompt;
inputting the task prompt into a generative machine learning model; and
in response to the inputting, receiving a task output from the generative machine learning model.

4. The method of claim 1, wherein the original tool prompt helps define a function tool and comprises one or more defining elements selected from a group consisting of:
a function declaration specifying an identifier of the function tool,
a function description that describes what the function tool does,
a parameter description that describes parameters used by the function tool, and
a return description that describes a type of output to be provided by the function tool in response to the function tool being invoked.

5. The method of claim 4, wherein the original tool prompt comprises a first number of the defining elements and the compressed tool prompt comprises a second number of the defining elements, the second number being smaller than the first number.

6. The method of claim 1, further comprising generating an associative tree data structure based on the multiple text chunks and at least one similarity metric, wherein the at least one similarity metric comprises a plurality of similarity metrics, and wherein connections between nodes of the associative tree data structure comprise corresponding similarity metrics, in the plurality of similarity metrics, specifying a similarity between nodes connected by a corresponding connection.

7. The method of claim 6, wherein generating the compressed tool prompt comprises pruning the associative tree data structure by removing nodes and paths which have only connections whose corresponding similarity metrics meet a predetermined criterion, to thereby generate a pruned associative tree data structure.

8. The method of claim 7, wherein generating the compressed tool prompt comprises traversing the pruned associative tree data structure to reconstruct a tool prompt that comprises less textual content than the original tool prompt.

9. The method of claim 1, wherein the at least one similarity metric is generated by executing at least one of a first algorithm that measures a largest difference between the first semantic distribution and the second semantic distribution, and a second algorithm that measures how much the first semantic distribution and the second semantic distribution agree or differ.

10. The method of claim 9, wherein the first algorithm is a K-S test algorithm, and the second algorithm is a Jensen-Shannon divergence algorithm.

11. The method of claim 1, wherein segmenting the original tool prompt into multiple text chunks comprises parsing the original tool prompt and generating text chunks based on an identification of at least one of tags, key words, phrases, or structural elements specific to functional tool descriptions in tool prompts.

12. The method of claim 1, wherein generating the first semantic distribution comprises processing the at least one semantic vector representation via a Gaussian Mixture Model (GMM), and wherein generating the second semantic distribution comprises processing the perturbed semantic vector representation via the GMM.

13. The method of claim 1, wherein generating at least one semantic vector representation of the multiple text chunks comprises generating a separate semantic vector representation for each text chunk in the multiple text chunks, and wherein generating the perturbed semantic vector representation comprises generating a separate perturbed semantic vector representation for each text chunk in the multiple text chunks other than the eliminated at least one text chunk.

14. A computer program product comprising:
a computer readable storage medium; and
program instructions stored on the computer readable storage medium to perform operations comprising:
receiving an original tool prompt for a generative machine learning model;
segmenting the original tool prompt into multiple text chunks;
generating at least one semantic vector representation of the multiple text chunks;
generating a first semantic distribution based on the at least one semantic vector representation;
generating a perturbed semantic vector representation based on a subset of the multiple text chunks, the subset being generated by eliminating at least one text chunk from the multiple text chunks;
generating a second semantic distribution based on the perturbed semantic vector representation;
performing a comparison of the first semantic distribution and the second semantic distribution to generate at least one similarity metric; and
generating, in response to the at least one similarity metric exceeding a threshold similarity value, a compressed tool prompt based on the subset of the multiple text chunks.

15. The computer program product of claim 14, wherein the operations further comprise storing the compressed tool prompt in a data storage that is accessible to an artificial intelligence agent that communicates with the generative machine learning model.

16. The computer program product of claim 14, wherein the operations further comprise:
adding the compressed tool prompt to a task prompt;
inputting the task prompt into a generative machine learning model; and
in response to the inputting, receiving a task output from the generative machine learning model.

17. The computer program product of claim 14, wherein the original tool prompt helps define a function tool and comprises one or more defining elements selected from a group consisting of:
a function declaration specifying an identifier of the function tool,
a function description that describes what the function tool does,
a parameter description that describes parameters used by the function tool, and
a return description that describes a type of output to be provided by the function tool in response to the function tool being invoked.

18. The computer program product of claim 17, wherein the original tool prompt comprises a first number of the defining elements and the compressed tool prompt comprises a second number of the defining elements, the second number being smaller than the first number.

19. The computer program product of claim 14, wherein the operations further comprise generating an associative tree data structure based on the multiple text chunks and at least one similarity metric, wherein the at least one similarity metric comprises a plurality of similarity metrics, and wherein connections between nodes of the associative tree data structure comprise corresponding similarity metrics, in the plurality of similarity metrics, specifying a similarity between nodes connected by a corresponding connection.

20. A computer system comprising:
a processor set;
one or more computer-readable storage media; and
program instructions stored on the one or more computer-readable storage media to cause the processor set to perform operations comprising:
receiving an original tool prompt for a generative machine learning model;
segmenting the original tool prompt into multiple text chunks;
generating at least one semantic vector representation of the multiple text chunks;
generating a first semantic distribution based on the at least one semantic vector representation;
generating a perturbed semantic vector representation based on a subset of the multiple text chunks, the subset being generated by eliminating at least one text chunk from the multiple text chunks;
generating a second semantic distribution based on the perturbed semantic vector representation;
performing a comparison of the first semantic distribution and the second semantic distribution to generate at least one similarity metric; and
generating, in response to the at least one similarity metric exceeding a threshold similarity value, a compressed tool prompt based on the subset of the multiple text chunks.
